(19) United States
(12) Patent Application Publication
(10) Pub. No.: US 2022/0350347 A1
(43) Pub. Date: Nov. 3, 2022

(54) NESTED-LOOP MODEL-FOLLOWING CONTROL LAW

(71) Applicant: Bell Textron Inc., Fort Worth, TX (US)

(72) Inventors: Steven G. Hagerott, Wichita, KS (US); Jonathan Andrew Toth, Irving, TX (US)

(73) Assignee: Bell Textron Inc., Fort Worth, TX (US)

(21) Appl. No.: 17/245,446

(22) Filed: Apr. 30, 2021

(51) Int. Cl. G05D 1/10; G05D 1/08; G05B 11/42

(52) U.S. Cl. CPC G05D 1/101; G05D 1/0825; G05B 11/42

(57) ABSTRACT

Embodiments are directed to systems and methods for utilizing a two-degree-of-freedom model-following control law within an architecture of nested loop functions. This allows for the separation of command and feedback path requirements and enables the restrictions of the inner loops to be applied to the outer loop feedbacks. This method of restriction allows a better allocation of coordinated authority between the loops.

### BACKGROUND

Aircraft are typically controlled by moveable aerodynamic surfaces on the wings and tail for controlling the altitude and attitude of the aircraft in flight, including roll, pitch, and yaw. Rotorcraft also use fixed or tiltable rotors to for control altitude and attitude. Aircraft and rotorcraft may use power-assisted or fully powered control systems to transmit an operator's control inputs to these surfaces. Most powered control systems use mechanical linkages to command the surface actuators, but “fly-by-wire” control systems are becoming more common. In these systems, the mechanical linkage is replaced by a computerized command and feedback loop.

### SUMMARY

Embodiments are directed to systems and methods for utilizing a two-degree-of-freedom model-following control law within an architecture of nested loop functions. This allows for the separation of command and feedback path requirements and enables the restrictions of the inner loops to be applied to the outer loop feedbacks. This method of restriction allows a better allocation of coordinated authority between the loops.

In an example embodiment, a method for operating a control surface or effector of an aircraft comprises receiving a reference command and generating an effector command based upon the reference command using a model-following control law. The model-following control law may comprise, for example, a command model and a transform arranged in a nested loop structure having an inner loop and an outer loop. The outer loop is subject to an inner loop constraint. The reference command is provided as an input to the command model, and the command model creates a desired dynamic response to the reference command. The method further comprises transforming the reference command to a feedforward command. The transform may be, for example, a derivative, filter derivative, scaling, or the like. The method further comprises combining the feedforward command with feedback command to create an inner loop command variable. The feedback commands may be generated using a proportional, integral, and derivative (PID) loop.

The inner loop command variable is provided to an inner loop controller. The inner loop controller may be an attitude or rate command controller, for example.

The reference command may be, for example, one of, but not limited to, a translational rate command (TRC), a heading command, a position command, an altitude command, a velocity command, a flight path angle command (e.g., a gamma (γ) command), or a vertical velocity command (e.g., an h-dot (\dot{h}) command).

In another example embodiment, a flight control system for an aircraft comprises an interface configured to receive a control input, such as from a pilot, and at least one effector operated by electronically controlled actuators. A computing device is configured to apply a control law using the control input and to operate the actuators to position or configure the at least one effector in response to the control law. The control law comprises a command model and transform arranged in a nested loop structure having an inner loop and an outer loop, wherein the outer loop is subject to an inner loop constraint, such as described above.

The control law may comprise the steps of applying the control input to a feedforward path comprising a command model and a transform. A feedforward signal from the transform is combined with a feedback signal to create a command to an inner loop controller. The inner loop controller generates commands to an aircraft plant. Feedback from the aircraft plant forms the outer loop and is provided to the feedforward signal.

In other embodiments, additional nesting of loops may be used. For example, the inner loop may be nested within a first outer loop, and the first outer loop may itself be nested within a second outer loop. There may be any number of additional outer loops allowing for any number of layers of nested loops.

### BRIEF DESCRIPTION OF THE DRAWINGS

Having thus described the invention in general terms, reference will now be made to the accompanying drawings, which are not necessarily drawn to scale, and wherein:

FIG. 1 depicts a rotorcraft that may incorporate a nested-loop model-following control law as disclosed herein.

FIG. 2 depicts an example tiltrotor aircraft that may incorporate a nested-loop model-following control law as disclosed herein. example tiltrotor aircraft.

FIGS. 3A and 3B illustrate an example tiltrotor aircraft that may incorporate a nested-loop model-following control law in accordance with embodiments described herein may be implemented and showing the aircraft configured to operate in a helicopter mode and an airplane mode, respectively.

FIGS. 4A-F are schematic illustrations of an aircraft having a distributed thrust array, including gimbal mounted propulsion systems operable for thrust vectoring, in accordance with embodiments of the present disclosure.

FIG. 5 is a block diagram showing an exemplary autopilot system for an aircraft.

FIG. 6 is a block diagram illustrating a nested-loop model-following control law structure.

FIG. 7 is a block diagram illustrating an example embodiment of a nested-loop model-following control law structure.

FIG. 8 is a block diagram illustrating a set of nested loops in which the input to an inner nested loop is generated by the outer nested loop 802 and each individual loop uses the nested-loop model-following control law structure disclosed herein.

While the system of the present application is susceptible to various modifications and alternative forms, specific embodiments thereof have been shown by way of example in the drawings and are herein described in detail. It should be understood, however, that the description herein of specific embodiments is not intended to limit the system to the particular forms disclosed, but on the contrary, the intention is to cover all modifications, equivalents, and alternatives falling within the spirit and scope of the present application as defined by the appended claims.

### DETAILED DESCRIPTION

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

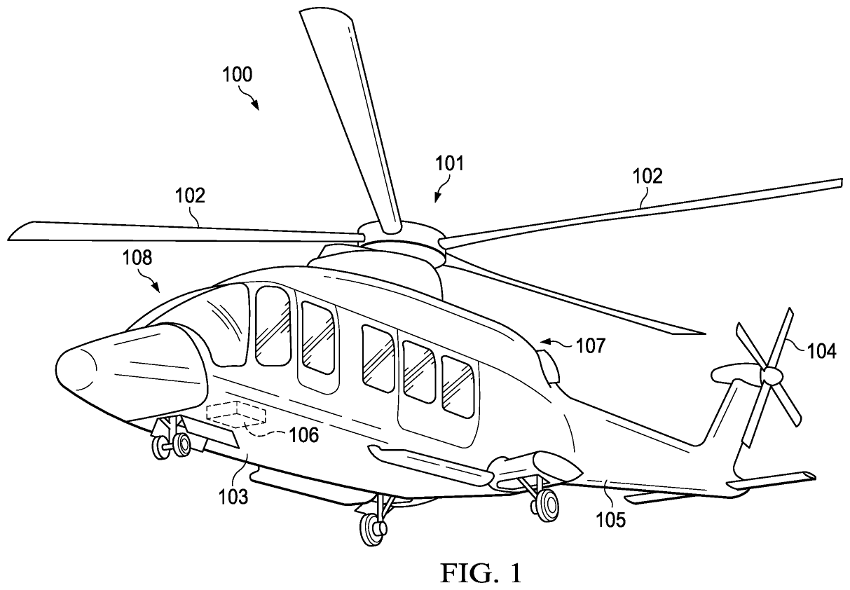

Referring to FIG. 1, a rotorcraft 100 is schematically illustrated. Rotorcraft 100 may incorporate a nested-loop model-following control law as disclosed herein. Rotorcraft 100 has a main rotor system 101 with a plurality of rotor blades 102. The pitch of rotor blades 102 can be collectively and cyclically manipulated to selectively control direction, thrust, and lift of rotorcraft 100. For example, the pitch of each main rotor blade 102 may be controlled by a swashplate in order to selectively control the attitude, altitude, and movement of the rotorcraft 100. The swashplate may be used to collectively and/or cyclically change the pitch of the main rotor blades. Rotorcraft 100 includes a fuselage 103, an anti-torque system 104, and an empennage 105. Anti-torque system 104 may include a tail rotor, no-tail-rotor (NOTAR), or dual main rotor system. In rotorcraft with a tail rotor, the pitch of each tail rotor blade is collectively changed in order to vary thrust of the anti-torque system, providing directional control of the rotorcraft 100. The pitch of the tail rotor blades is changed by one or more tail rotor actuators. In some embodiments, a fly-by-wire (FBW) system 106 sends electrical signals to the main rotor actuators or tail rotor actuators to control flight of rotorcraft 100.

Power is supplied to the main rotor system 101 and the anti-torque system 104 by one or more engines 107. The engines 107 may be controlled according to signals from the FBW system 106. The output of the engine 107 is provided to a driveshaft that is mechanically and operatively coupled to the main rotor system 101 and the anti-torque system 104 through a main rotor transmission and a tail rotor transmission, respectively.

The empennage 105 may have other flight control devices such as horizontal or vertical stabilizers, rudder, elevators, or other control or stabilizing surfaces that are used to control or stabilize flight of the rotorcraft 100. The fuselage 103 includes a cockpit 107, which includes displays, controls, and instruments. In some embodiments, cockpit 108 is configured to accommodate a pilot or a pilot and co-pilot. It is also contemplated, however, that rotorcraft 100 may be operated remotely, in which case cockpit 108 could be configured as a fully functioning cockpit to accommodate a pilot (and possibly a co-pilot as well) to provide for greater flexibility of use or could be configured with a cockpit having limited functionality (e.g., a cockpit with accommodations for only one person who would function as the pilot operating perhaps with a remote co-pilot or who would function as a co-pilot or back-up pilot with the primary piloting functions being performed remotely). In yet other contemplated embodiments, rotorcraft 100 could be configured as an unmanned vehicle, in which case cockpit 108 could be eliminated entirely in order to save space and cost.

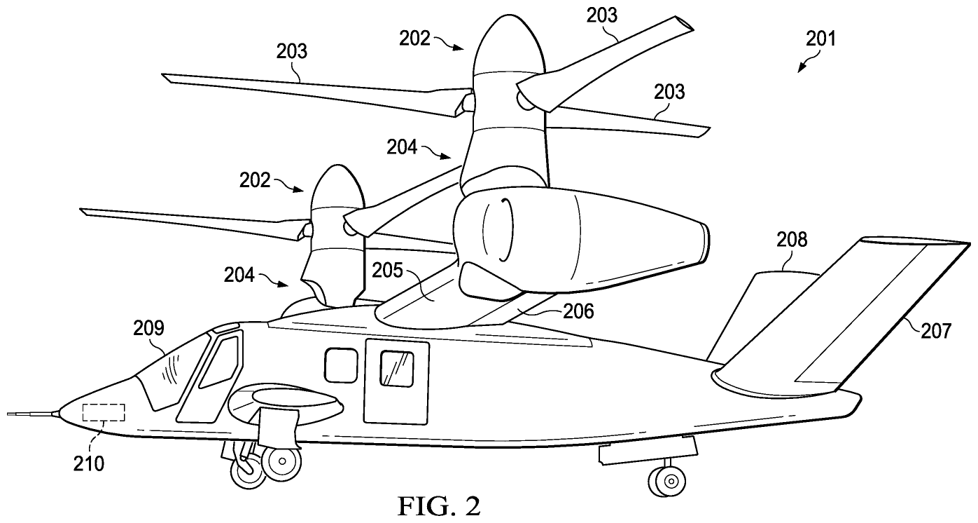

FIG. 2 is an oblique view of an example tiltrotor aircraft 201. Tiltrotor aircraft 201 may incorporate a nested-loop model-following control law as disclosed herein. Tiltrotor aircraft 201 has two proprotors 202. Each proprotor 202 has plurality of rotor blades 203 that are driven by an engine 204. Although FIG. 2 shows tiltrotor aircraft 201 in a helicopter mode wherein proprotors 202 are oriented substantially vertical to provide a lifting thrust. It will be understood that in other embodiments, tiltrotor aircraft 201 may operate in an airplane mode wherein proprotors 202 are oriented substantially horizontal to provide a forward thrust. Proprotors 202 may also move between the vertical and horizontal positions during flight as tiltrotor aircraft 201 transitions between a helicopter mode and an airplane mode.

Proprotors 202 and engines 204 are mounted on wings 205, which are attached to a fuselage 206. Wings 205 may provide lift to tiltrotor aircraft 201 in certain flight modes (e.g., during forward flight airplane mode) in addition to supporting rotatable nacelles for engines 204 and proprotor systems 202. Control surfaces 206 on wings 205 and/or control surfaces 207 on a tail section 208 may be used to adjust the attitude of tiltrotor aircraft 201 around the pitch, roll, and yaw axes while in airplane mode. Control surfaces 206 and 207 may be, for example, ailerons, flaps, slats, spoilers, elevators, or rudders that are controlled by cyclic controllers, pedals, or other flight controls within cockpit 209 of fuselage 206.

Like rotorcraft 100, tiltrotor aircraft 201 may have an FBW system 210 that sends electrical signals to control aircraft actuators, such as actuators for control surfaces 206 and 207 and conversion actuators for rotating proprotors 202, and engines 204. Also, like rotorcraft, tiltrotor aircraft 201 may be configured for manned or unmanned flight, wherein cockpit 209 may be configured to accommodate a pilot or to be operated remotely.

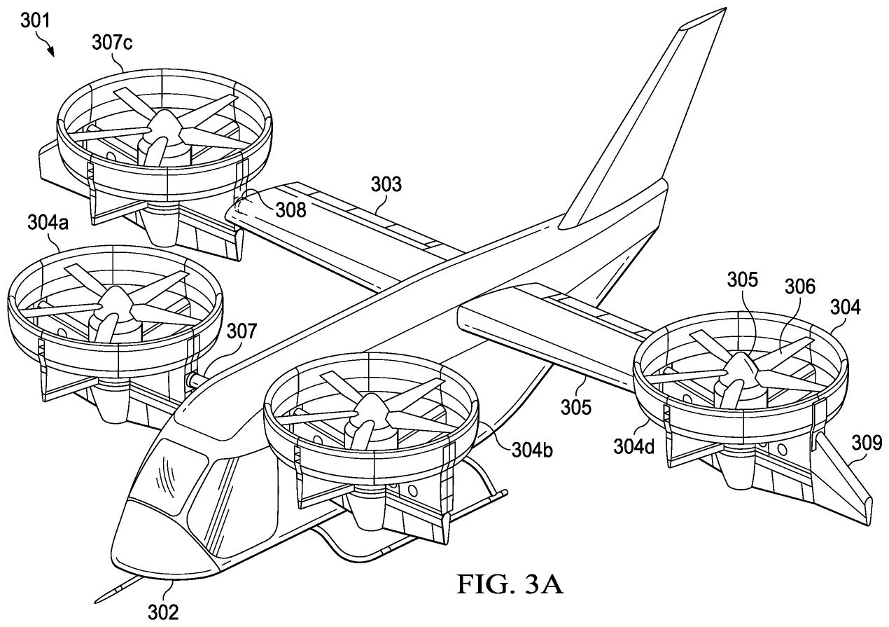

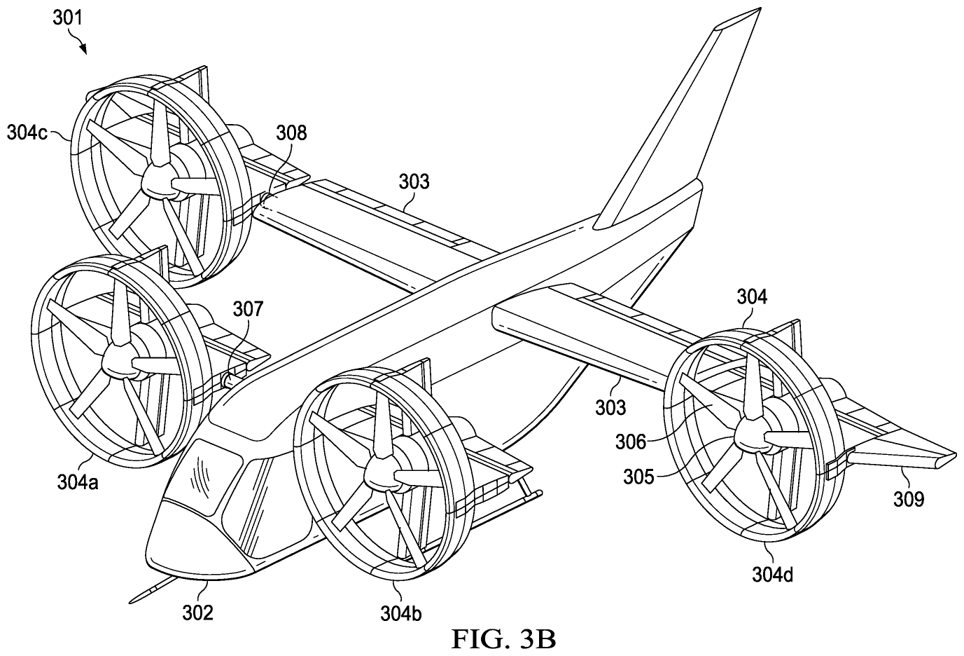

FIGS. 3A and 3B illustrate an example tiltrotor aircraft 301 that includes ducted rotors (or fans). Tiltrotor aircraft 301 is convertible between a helicopter mode (shown in FIG. 3A), which allows for vertical takeoff and landing, hovering, and low speed directional movement, and an airplane mode (shown in FIG. 3B), which allows for forward flight as well as horizontal takeoff and landing.

Aircraft 301 comprises a fuselage 302 with a fixed wing 303 that extends therefrom and a plurality of rotatable ducts 304. Each duct 304 houses a power plant for driving an attached rotor 305 in rotation. Each rotor 305 has a plurality of blades 306 configured to rotate within ducts 304.

In the illustrated embodiment, aircraft 301 is configured with four ducts 304, including two ducts 304a and 304b that form a forward pair of ducts and two ducts 304c and 304d that form an aft pair of ducts. Each duct 304 is rotatably coupled to fuselage 302 of aircraft 301 via a spindle. Ducts 304a and 304b are coupled directly to fuselage 302 by a respective spindle 307. Ducts 304c and 304d are each independently coupled to a corresponding end of wing 303 via a respective spindle 308. As shown, each of ducts 304c and 304d includes a winglet 309 that is coupled thereto. It should be appreciated that aircraft 301 is not limited to the illustrated configuration having four ducts 304, and that aircraft 301 may alternatively be implemented with more or fewer ducts 304.

The position of ducts 304, and optionally the pitch of blades 306, can be selectively controlled to control direction, thrust, and lift of rotors 305. For example, ducts 304 are repositionable to convert aircraft 301 between a helicopter mode and an airplane mode. As shown in FIG. 3A, ducts 304 are positioned such that aircraft 301 is in helicopter mode, which allows for vertical takeoff and landing, hovering, and low-speed directional movement. As shown in FIG. 3B, ducts 304 are positioned such that aircraft 301 is in airplane mode, which allows for high-speed forward-flight. In airplane mode, ducts 304 direct their respective thrusts in the aft direction to propel aircraft 301. Aircraft 301 is operable to fly in all directions during the vertical takeoff and landing (i.e., helicopter) mode configuration of FIG. 3A, although faster forward flight is achievable while in the forward flight (i.e., airplane) mode configuration of FIG. 3B2. Ducted fans 304 may be tiltable between the vertical and horizontal positions by spindles 307, 308, which are rotatable in response to commands originating from a pilot and/or a flight control system of the aircraft 301.

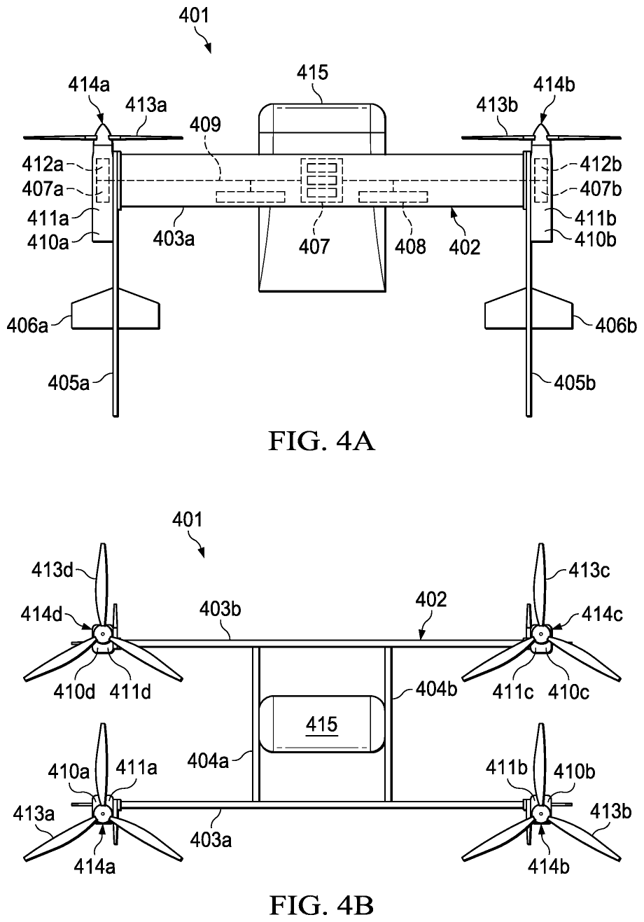

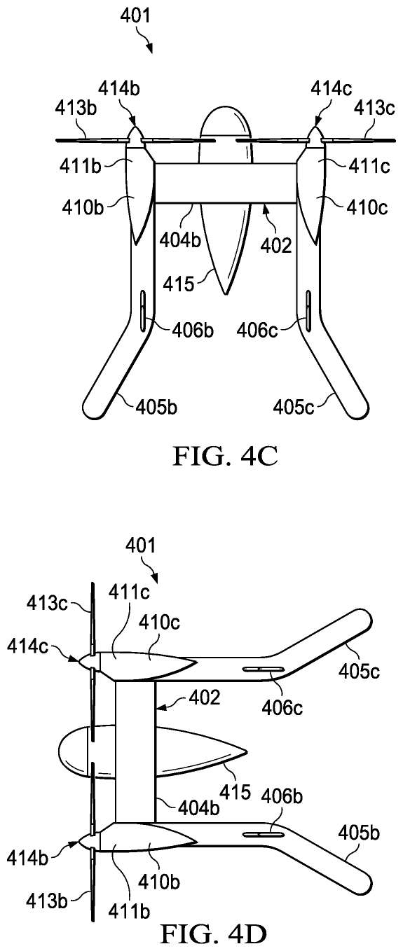

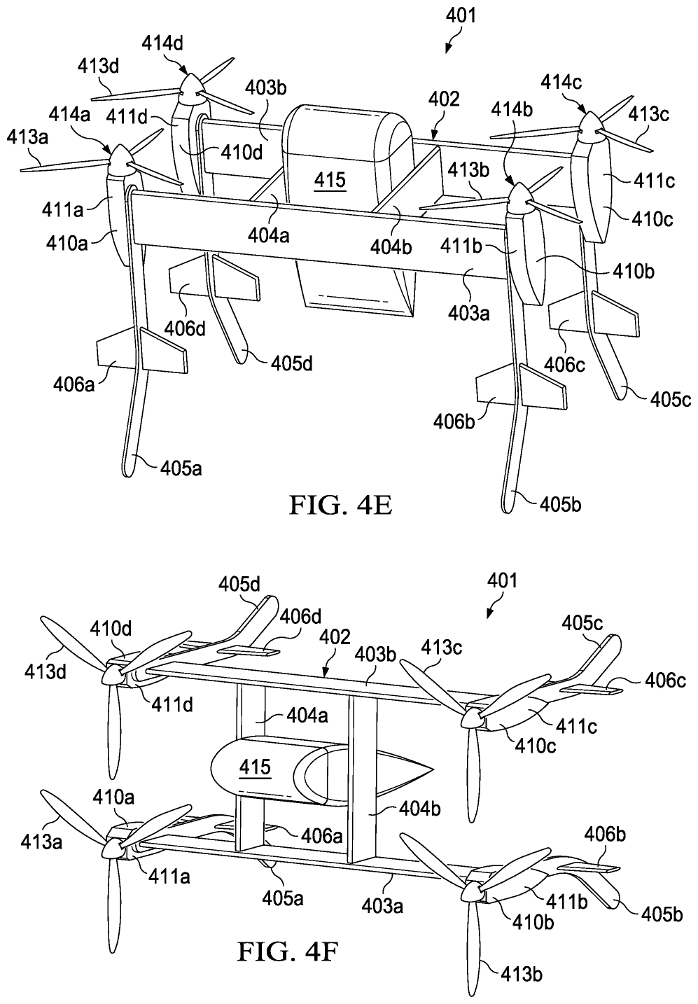

Referring to FIGS. 4A-4F, various views are depicted for an aircraft 401 having a distributed thrust array, including gimbal mounted propulsion systems operable for thrust vectoring. FIGS. 4A, 4C, 4E depict aircraft 401 in thrust-borne flight, which may also be referred to as the vertical takeoff and landing or VTOL flight mode of aircraft 401. FIGS. 4B, 4D, 4F depict aircraft 401 in wing-borne flight which may also be referred to as the forward or high-speed forward flight mode of aircraft 401. In the illustrated embodiment, the airframe 402 of aircraft 401 includes wings 403a, 403b each having an airfoil cross-section that generates lift responsive to the forward airspeed of aircraft 401. Wings 403a,b may be formed as single members or may be formed from multiple wing sections. The outer skins for wings 403a,b are preferably formed from high strength and lightweight materials, such as fiberglass, carbon, plastic, metal, or other suitable material, or combination of materials. As illustrated herein, wings 403a,b are straight wings. In other embodiments, wings 403a,b could have other designs, such as polyhedral wing designs, swept wing designs, or other suitable wing designs.

Extending generally perpendicularly between wings 403a,b are two truss structures depicted as pylons 404a, 404b. In other embodiments, more than two pylons may be present. Pylons 404a,b are preferably formed from high strength and lightweight materials, such as fiberglass, carbon, plastic, metal, or other suitable material, or combination of materials. Wings 403a,b and pylons 404a,b may be coupled together at the respective intersections using mechanical connections such as bolts, screws, rivets, adhesives, and/or any other suitable joining technique. Extending generally perpendicularly from wings 403a,b are landing gear depicted as tail members 405a-d that enable aircraft 401 to operate as a tail-sitting aircraft. In the illustrated embodiment, tail members 405a-d are fixed landing struts. In other embodiments, tail members 405a-d may include passively operated pneumatic landing struts or actively operated telescoping landing struts with or without wheels for ground maneuvers. Tail members 405a-d each include a control surface 406a-d, respectively, that may be passive or active aerosurfaces that serve as vertical stabilizers and/or elevators during wing-borne flight and serve to enhance hover stability during thrust-borne flight.

Wings 403a,b and pylons 404a,b preferably include central passageways operable to contain flight control systems, energy sources, communication lines, and other desired systems and connections. For example, as best seen in FIG. 4A, wing 403a houses the flight control system 407 of aircraft 401. In some embodiments, a redundant flight control system 407 having multiple independent flight control computers may be used to improve the overall safety and reliability of aircraft 401 in the event of a failure. Flight control system 407 preferably includes non-transitory computer readable storage media including a set of computer instructions executable by one or more processors for controlling the operation of aircraft 401. Flight control system 407 may be implemented on one or more general-purpose computers, special purpose computers or other machines with memory and processing capability. For example, flight control system 407 may include one or more memory storage modules including, but is not limited to, internal storage memory such as random access memory (RAM), non-volatile memory such as read only memory (ROM), removable memory such as magnetic storage memory, optical storage, solid-state storage memory, or other suitable memory storage entity. Flight control system 407 may be a microprocessor-based system operable to execute program code in the form of machine-executable instructions. In addition, flight control system 407 may be selectively connectable to other computer systems via a proprietary encrypted network, a public encrypted network, the Internet, or other suitable communication network that may include both wired and wireless connections.

In the illustrated embodiment, wings 403a,b and/or pylons 404a,b may contain one or more of electrical power sources depicted as batteries 408 in wing 403a, as best seen in FIG. 4A. Batteries 408 supply electrical power to flight control system 407. In some embodiments, batteries 408 may be used to supply electrical power for the distributed thrust array of aircraft 401. Wings 403a,b and/or pylons 404a,b also contain a communication network 409 that enables flight control system 407 to communicate with the distributed thrust array of aircraft 401.

In the illustrated embodiment, the distributed thrust array includes four propulsion assemblies 410a-d that are independently operated and controlled by flight control system 407. It should be noted, however, that the distributed thrust array of the present disclosure could have any number of independent propulsion assemblies including six, eight, twelve, sixteen, or other number of independent propulsion assemblies. Flight control system 407 also controls other effectors, such as control surfaces 406a-d, which may be modulated via the flight control system for higher speed trim and control. Propulsion assemblies 410a-d are independently attachable to and detachable from airframe 402. For example, propulsion assemblies 410a-d are preferably standardized and interchangeable units that are most preferably line replaceable propulsion units enabling easy installation and removal from airframe 402. Propulsion assemblies 410a-d may be coupled to wings 403a,b using quick connect and disconnect couplings techniques including bolts, pins, cables, or other suitable coupling techniques. In addition, the use of line replaceable propulsion units is beneficial in maintenance situations if a fault is discovered with one of the propulsion units. In this case, the faulty propulsion unit can be decoupled from airframe 402 by simple operations and another propulsion unit can then be attached to airframe 402. In other embodiments, propulsion assemblies 410a-d may be permanently coupled to wings 403a,b by riveting, bonding, and/or other suitable technique.

As illustrated, propulsion assemblies 410a-d are coupled to the outboard ends of wings 403a, 403b. In other embodiments, propulsion assemblies 410a-d could have other configurations including close coupled configurations, high wing configurations, low wing configurations, or any other suitable configuration. In the illustrated embodiment, the four independently operating propulsion assemblies 410a-d form a two-dimensional thrust array with each of the propulsion assemblies having a symmetrically disposed propulsion assembly. For example, propulsion assemblies 410a,c are symmetrically disposed propulsion assemblies and propulsion assemblies 410b,d are symmetrically disposed propulsion assemblies. It should be noted, however, that a two-dimensional thrust array of the present disclosure could have any number of independent propulsion assemblies including six, eight, twelve, sixteen or other number of independent propulsion assemblies that form the two-dimensional thrust array with each of the propulsion assemblies having a symmetrically disposed propulsion assembly.

In the illustrated embodiment, each propulsion assembly 410a-d includes a housing 411a-d, that contains components such as an electric motor, a gimbal, one or more actuators, and an electronics node including, for example, batteries, controllers, sensors, and other desired electronic equipment. Only electric motors 412a,b and electronics nodes 407a,b are visible in FIG. 4A. The electric motors of each propulsion assembly 410a-d are preferably operated responsive to electrical energy from the battery or batteries disposed with that housings, thereby forming a distributed electrically powered thrust array. Alternatively, or additionally, electrical power may be supplied to the electric motors and/or the batteries disposed with the housing from batteries 408 carried by airframe 402 via communications network 409. In other embodiments, the propulsion assemblies may include internal combustion engines or hydraulic motors.

Flight control system 407 communicates via communications network 409 with the electronics nodes of each propulsion assembly 410a-d, such as electronics node 407a of propulsion assembly 410a and electronics node 407b of propulsion assembly 410b. Flight control system 407 receives sensor data from and sends flight command information to the electronics nodes of each propulsion assembly 410a-d such that each propulsion assembly 410a-d may be individually and independently controlled and operated. For example, flight control system 407 is operable to individually and independently control the operating speed and thrust vector of each propulsion assembly 410a-d. Flight control system 407 may autonomously control some or all aspects of flight operation for aircraft 401. Flight control system 407 is also operable to communicate with remote systems, such as a ground station via a wireless communications protocol. The remote system may be operable to receive flight data from and provide commands to flight control system 407 to enable remote flight control over some or all aspects of flight operation for aircraft 401. The autonomous and/or remote operation of aircraft 401 enables aircraft 401 to perform unmanned logistic operations for both military and commercial applications.

Each propulsion assembly 410a-d includes a rotor assembly 413a-d. Each rotor assembly 413a-d is directly or indirectly coupled to an output drive of a respective electrical motor 412a-d that rotates the rotor assembly 413a-d in a rotational plane to generate thrust for aircraft 401. In the illustrated embodiment, rotor assemblies 413a-d each include three rotor blades having a fixed pitch. In other embodiments, the rotor assemblies could have other numbers of rotor blades both less than and greater than three. Alternatively, or additionally, the rotor assemblies could have variable pitch rotor blades with collective and/or cyclic pitch control. Each electrical motor 412a-d is paired with a rotor assembly 413a-d, for example electrical motor 412a and rotor assembly 413a, to form a propulsion system 414a-d. As described herein, each propulsion system 414a-d may have a single-axis or a two-axis tilting degree of freedom relative to housings 411a-d and thus airframe 402 such that propulsion systems 414a-d are operable for thrust vectoring. In the illustrated embodiment, the maximum angle of the thrust vector may preferably be between about 10 degrees and about 30 degrees, may more preferably be between about 15 degrees and about 25 degrees and may most preferably be about 20 degrees. Notably, using a 20-degree thrust vector yields a lateral component of thrust that is about 34 percent of total thrust. In other embodiments, the propulsion systems may not have a tilting degree of freedom. In which case, propulsion systems 414a-d may not be capable of thrust vectoring. As such, aircraft 401 may have no thrust vectoring capabilities, single-axis thrust vectoring capabilities, or two-axis thrust vectoring capabilities associated with each propulsion assembly 410a-d.

Aircraft 401 may operate as a transport aircraft for a pod assembly 415 that is fixed to or selectively attachable to and detachable from airframe 402. In the illustrated embodiment, pylons 404a,b include receiving assemblies for coupling with pod assembly 415. The connection between pylons 404a,b and pod assembly 415 may be a fixed connection that secures pod assembly 415 in a single location relative to airframe 402. Alternatively, pod assembly 415 may be allowed to rotate and/or translate relative to airframe 402 during ground and/or flight operations. For example, it may be desirable to have pod assembly 415 low to the ground for loading and unloading cargo but more distant from the ground for takeoff and landing. As another example, it may be desirable to change the center of mass of pod assembly 415 relative to airframe 402 during certain flight conditions such as moving the center of mass of pod assembly 415 forward relative to airframe 402 during high-speed wing-borne flight. Similarly, it may be desirable to lowering the center of mass of pod assembly 415 relative to airframe 402 during hover in the event of a partial or total failure of one of the propulsion assemblies. As illustrated, pod assembly 415 may be selectively coupled to and decoupled from airframe 402 to enable sequential pickup, transportation and delivery of multiple pod assemblies 415 to and from multiple locations.

Airframe 402 preferably has remote release capabilities of pod assembly 415. For example, this feature allows airframe 402 to drop pod assembly 415 at a desire location following transportation. In addition, this feature allows airframe 402 to jettison pod assembly 415 during flight, for example, in the event of an emergency situation, such as a propulsion assembly or other system of aircraft 401 becoming compromised. One or more communication channels may be established between pod assembly 415 and airframe 402 when pod assembly 415 is attached therewith. A quick disconnect harness may be coupled between pod assembly 415 and airframe 402 such that flight control system 407 may send commands to pod assembly 415 to perform functions. For example, flight control system 407 may operate doors of pod assembly 415 between open and closed positions to enable loading and unloading of a payload to be transported within pod assembly 415.

It should be appreciated that aircraft 100, 201, 301, and 401 are merely illustrative of a variety of aircraft that can implement the embodiments disclosed herein. Other aircraft implementations may include, for example, hybrid aircraft, fixed wing aircraft, unmanned aircraft, gyrocopters, drone aircraft, and other helicopter configurations, to name a few examples. It should be appreciated that even though aircraft are particularly well suited to implement the embodiments of the present disclosure, non-aircraft vehicles, such as trucks and ships, and devices can also implement the embodiments.

FBW systems (e.g., 106, 210, 407) are provided in aircraft, such as aircraft 100, 201, 301, or 401, to assist pilots in stably flying the rotorcraft and to reduce workload on the pilots. The FBW systems may provide different control characteristics or responses for cyclic, pedal, or collective control input in the different flight regimes and may provide stability assistance or enhancement by decoupling physical flight characteristics so that a pilot is relieved from needing to compensate for some flight commands issued to the rotorcraft. FBW systems may be implemented in one or more flight control computers (FCCs) disposed between the pilot controls and flight control systems, providing corrections to flight controls that assist in operating the rotorcraft more efficiently or that put the rotorcraft into a stable flight mode while still allowing the pilot to override the FBW control inputs. The FBW systems in a rotorcraft may, for example, automatically adjust power output by the engine to match a collective control input, apply collective or power correction during a cyclic control input, provide automation of one or more flight control procedures, provide for default or suggested control positioning, or the like.

In some embodiments, the FBW system includes an autopilot function that provides automatic flight control for the aircraft. The autopilot may be capable of controlling some or all aircraft flight parameters, such as maintaining speed, heading, or altitude, or managing operations, such as hovering and navigating. The autopilot can relive a pilot of time-intensive tasks and reduce the pilot's workload.

In some embodiments, the autopilot system provides flight commands to a flight control computer. The flight control computer interprets the flight commands and controls effectors and actuators for control surfaces, such as ailerons, flaps, elevators, and rudder. In response to the autopilot's commands, the flight control computer may also signal actuators that control an angular position of the proprotors for a tiltrotor aircraft as well as the angle of attack of rotor blades. In various embodiments, the effectors may be electric motors and may in various embodiments may be, for example, swashplate actuators, nacelle-position actuators, throttle actuators, landing-gear actuators, or any other type of actuator for controlling a flight parameter. The effectors may also include, for example, rotors, rotor cyclic controls, rotor/propellor collective control, electric motor speed, torque, or current command, propellors, ailerons, rudders, elevators, etc.

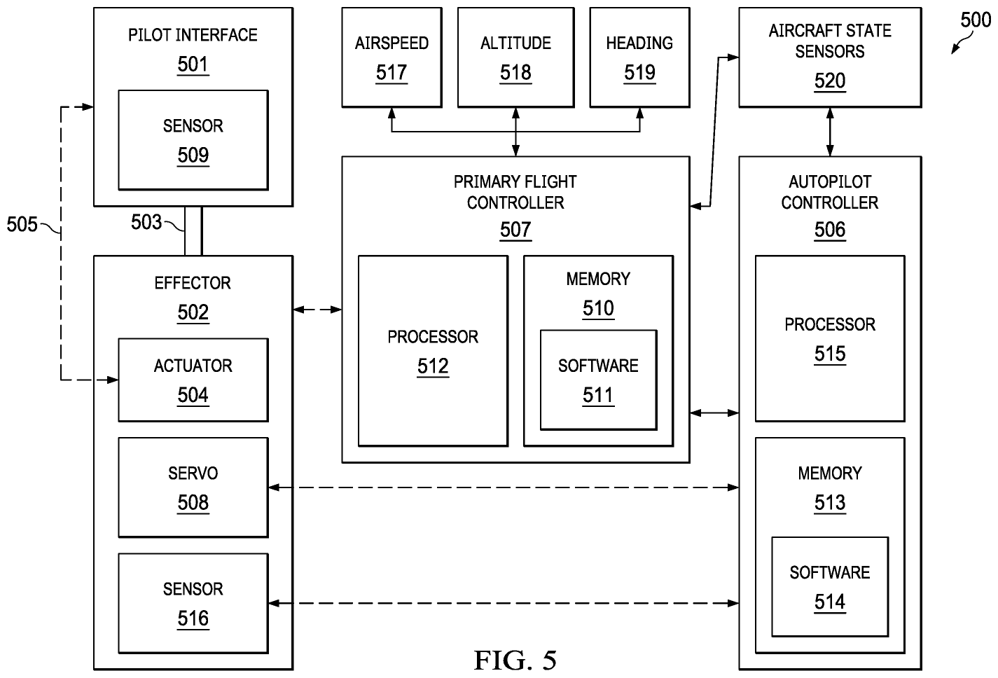

FIG. 5 is a block diagram showing an exemplary autopilot system 500 for an aircraft. Autopilot system 500 may incorporate a nested-loop model-following control law. System 500 may be implemented on any aircraft having a control surface controllable via a pilot interface and/or an autopilot controller for providing automatic control of the control surface. A pilot interface 501 receives control inputs from a pilot for transmitting the control inputs to an effector 502, such as a control surface, propellor, ducted propellor, etc. The control inputs may be transmitted directly to effector 502 via a mechanical linkage 503, or control signals may be transmitted to an actuator 504 of effector 502 via a signaling path 505 (e.g., in a fly-by-wire arrangement), or some combination of these may be employed. Actuator 504 may be, for example, a hydraulically powered or electrically powered actuator that responds to electrical control signals from pilot interface 501 or from an FCC, such as autopilot controller 506, flight controller 507, flight director, waypoint navigator, navigation computer, or other navigation solution.

Autopilot controller 506 may receive input commands from a flight controller 507 and transmit commands to a servo 508 adapted to drive effector 502 based on the input commands. Servo 508 may drive effector 502 directly or may drive mechanical linkage 503 or actuator 504. Effector 502 is for example one or more of an aileron, elevator, horizontal stabilizer, flap, slat, spoiler, or rudder. Alternatively, effector 502 may represent an engine control, rotor blade actuator, or proprotor configuration actuator. Although only one effector 502 is depicted in FIG. 5 for clarity of illustration, in practice system 500 is used to control a plurality of effectors onboard an aircraft via at least one autopilot servo (e.g., a roll autopilot servo and a pitch autopilot servo).

Pilot interface 501 may be, for example, a control wheel, center stick, yoke, or other interface located onboard the aircraft or remotely (e.g., by a pilot of an unmanned aerial vehicle (UAV)). In certain embodiments, pilot interface 501 includes a first interface for a pilot and a second interface for a copilot (not shown), with the first and second interfaces configured to move in concert via one or more mechanical linkages (e.g., a roll mechanical linkage and a pitch mechanical linkage). In some embodiments, mechanical linkage 503 includes a known mechanical gearing that mechanically couples pilot interface 501 with servo 508. During autopilot operation, pilot interface 501 may move according to command inputs implemented by autopilot controller 506 via mechanical linkage 503.

A sensor 509 is mechanically coupled to pilot interface 501 for measuring a position of pilot interface 501. For example, sensor 509 may be one or more rotary variable differential transformers (RVDTs) used to measure rotations of pilot interface 501 (e.g., a control wheel rotation and/or a control stick pivot angle). In certain embodiments, sensor 509 includes a plurality of RVDTs configured as a set for determining an angle in a three-axis (e.g., X, Y, Z) space for commanding aircraft motions.

Flight controller 507 has a memory 510, including a non-transitory medium for storing software 511, and a processor 512 for executing instructions of software 511. Memory 510 in some embodiments is a memory system that includes both transitory memory such as RAM and non-transitory memory such as, ROM, EEPROM, Flash-EEPROM, magnetic media including disk drives, and optical media. Memory 510 stores software 512 as machine readable instructions executable by processor 512. In certain embodiments, flight controller 507 includes one or more flight computers (e.g., a primary flight computer and a backup flight computer). Flight controller 507 is configured to communicate with pilot interface 501, sensor 509, autopilot controller 506, effector 502, and actuator 504 by one of a wired and/or wireless communication medium.

Autopilot controller 506 has a memory 513, including a non-transitory medium for storing software 514, and a processor 515 for executing instructions of software 514. In certain embodiments, autopilot controller 506 includes one or more microprocessor, microcontroller, programmable logic controller, and printed circuit boards. Autopilot controller 506 is adapted to communicate with servo 508 and flight controller 507 by one of a wired and/or wireless communication medium. In certain embodiments, autopilot controller 506 and servo 508 are implemented as an integrated autopilot servo device, such as a roll autopilot servo for driving effector 502 (e.g., a roll spoiler and/or an aileron) for providing roll function. Autopilot controller 507 determines command signals for commanding servo 508 based on a bank angle and/or a roll rate (e.g., from sensor 509 or primary flight controller 507), and in some embodiments, based on air data from controller 507.

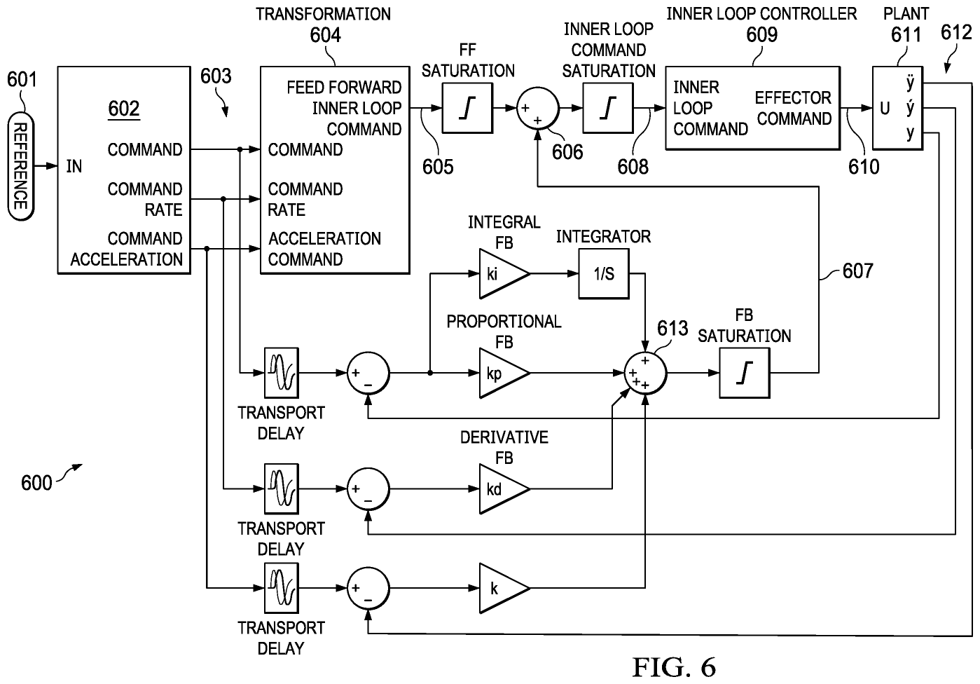

Exemplary instructions of software 511 and/or 514 include nested-loop model-following control law instructions as described herein. The nested-loop model-following control law utilizes a two-degree-of-freedom model-following control law within an architecture of nested-loop functions, such as the structured described below as illustrated in FIG. 6. The nested-loop model-following control law allows for separation of command and feedback path requirements and enables restrictions of the inner loops to be applied to the outer loop feedbacks. This method of restriction allows for a better allocation of coordinated authority between the loops.

Autopilot 506 may be engaged and directed to maintain a commanded state, such as desired heading, airspeed, or altitude, for example. The desired parameter may be input using pilot interface 501 by an onboard or remote pilot. Software instructions 514 include an algorithm that applies the nested-loop model-following control law as described herein to drive the aircraft to the commanded state using autopilot commands to one or more effector 502. Once within the desired parameters, autopilot 506 then maintains that state by generating corrective command signals to effector 502.

Generally, it is desired that autopilot 506 provide a relatively slow response to changes in command, such as smoothly moving to the commanded heading, airspeed, or altitude. However, it is also desired that autopilot 506 responds to disturbances quickly, such as external wind gusts and turbulence. The nested-loop model-following control law allows for different responses to pilot interface command as opposed to external forces on the aircraft. For example, in a rotorcraft, a translational rate command (TRC) function is used to enable low-speed precise maneuvering flight so that the rotorcraft's translational ground speed will follow the position of the cyclic. Using the nested-loop model-following control law structure disclosed herein, when operating in a TRC mode, for example, the aircraft's response to the stick may be slower than its response to wind gusts. Essentially, this means that the response to desired inputs may be different than the response to a disturbance.

In certain embodiments, autopilot controller 506 may lack information about an absolute position of servo 508. As such, a sensor 516 may optionally be coupled with servo 508 for determining a position of servo 508. For example, sensor 516 may be a set of hall-effect sensors positioned around an electrical motor shaft of servo 508 for determining an angular rotation position of the electrical motor shaft. Alternatively, sensor 516 may be coupled to mechanical linkage 503 for determining a position of servo 508. In some embodiments, servo 508 drives both a roll spoiler and an aileron in a coordinated manner for providing roll functionality, and sensor 516 may be used to determine a position of both the roll spoiler and the aileron.

Flight controller 507 and autopilot controller 506 measure a response of the aircraft to commands. In various embodiments, the flight controller 507 and autopilot controller 506 measure the aircraft response by measuring flight parameters, such as, for example, actual altitude, actual rate of climb, actual airspeed, actual heading, and other flight parameters. Such parameters may be measured using, for example, airspeed sensor 517, altitude sensor 518, and heading sensor 519. Sensors 517-519 may be associated with an aircraft pitot static system, compass, GPS, navigation system, accelerometers, etc. Other sensors 520 may also be used to provide aircraft state data to autopilot controller 506 and primary flight controller 507.

FIG. 6 is a block diagram illustrating a nested-loop, model-following, control law system 600. A reference signal 601 is provided as an input to a command model 602, which may represent the desired dynamics of an aircraft. Reference signal 601 may be, for example, one or more of a TRC command, a heading command, a position command, an altitude command, a velocity command, a flight path angle command, a vertical velocity command, a load factor (Nz) command, a pitch rate command, a roll rate command, or an angle of attack command. Command model 602 provides one or outputs 603 to a transform 604 in a feedforward path. Outputs 603 may comprise, for example, a command variable, a command rate (i.e., a first derivative of the command variable), and/or a command acceleration (i.e., a second derivative of the command variable). In other embodiments, the outputs 603 may comprise a filtered version of the reference command 601 and/or a filtered derivative of the reference command 601.

Transform 604 translates the outputs 603 of the command model 602 to a forward path signal 605. The forward path signal 605 may be, for example, an attitude command or a rate command for an aircraft. The forward path signal 605 is compared at 606 with a feedback signal 607 from an outer loop. The output of the comparison 606 is then provided as an inner loop command 608 to inner loop controller 609. The inner loop controller 609 generates one or more effector commands 610 for plant 611. Effectors may comprise any device that imparts moments and forces on an aircraft, such as any aerodynamic or propulsive device. The effectors may include, for example and without limitation, propellors, ducted propellors, rotors, or flight control surfaces that are controlled by an actuator that may adjust the speed, RPM, pitch angle, deflection angle, or other characteristic of the effector.

One or more feedback signals 612 may be provided by plant 611. The feedback signals 612 may comprise, for example, a parameter (y), a derivative (\dot{y} or y-dot) of the parameter (i.e., a rate), and/or a second derivative (ÿ or y-double dot) of the parameter (i.e., an acceleration). The outputs used as feedback signals 612 may be estimated or may be directly measured. The feedback signals 612 may be summed with their respective command model outputs 603 and then summed together at 613 to create feedback signal 607. Feedback signals may be a proportional, integral, and derivative (PID) loop. Appropriate delay, scaling, and/or limits may also be applied to the feedforward and feedback signals. The feedback signals may also employ notch filters, lead-lag filters, or other filters to meet performance and stability requirements using methods known to those of ordinary skill in the art.

Although the system 600 of FIG. 6 illustrates three command model outputs 603 and three corresponding plant feedback signals 612, it will be understood that in other embodiments any one or more of these signals may be used depending upon the implementation. For example, in some implementations a rate or acceleration portion of the feedback signals 612 may not be required if a corresponding parameter is not provided by the command model 602.

FIG. 6 illustrates a two-level nested system 600 in which an outer loop generates an inner loop command 608 for inner loop controller 609. In other embodiments, further nesting of the system may be used. The inner loop controller 609 may comprise another version of nested-loop controller 600 such that inner loop command signal 608 is applied as a reference signal 601 to a second command model 602 within inner loop controller 609. It will be understood that any number of layers of nested loops may be used. For example, a first outer loop may use an altitude reference that is input to a command model to generate an h-dot (h) or vertical velocity command as an inner loop command 608. The h-dot command may then be applied as a reference to a second or nested loop 600 that generates a pitch attitude as a nested inner loop command 608.

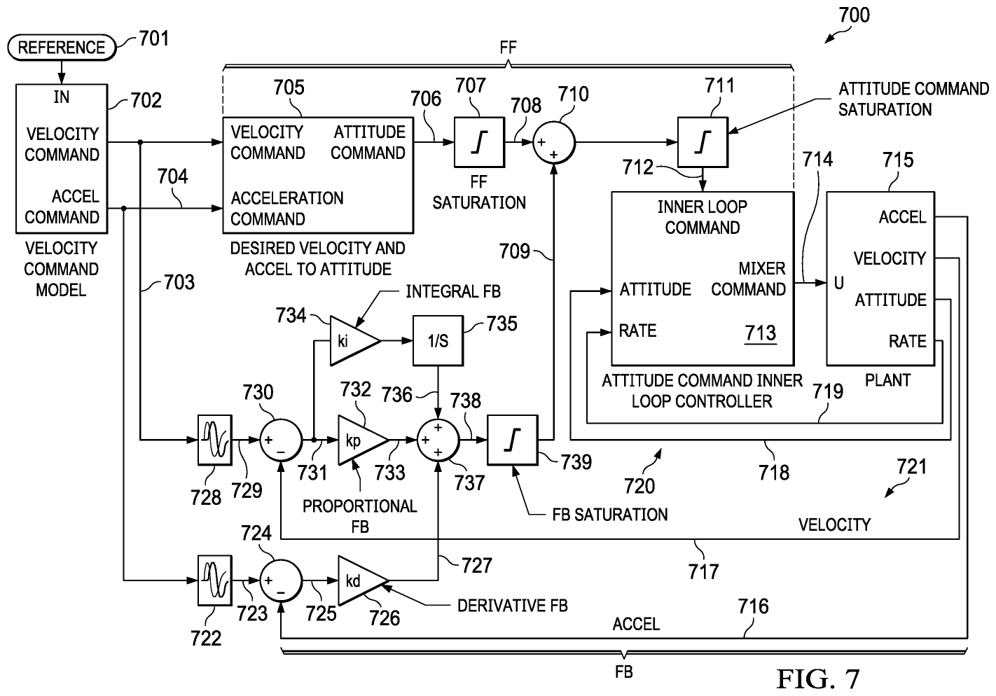

FIG. 7 is a block diagram illustrating a nested-loop model-following control law structure 700 according to an example embodiment. A reference signal 701 is provided as an input to velocity command model 702. Reference signal 701 is a velocity command in the example illustrated in FIG. 7; however, in other embodiments, reference 701 may be a TRC command, a heading command, a position command, an altitude command, a velocity command, a flight path angle command, or a vertical velocity command. Reference 701 may be provided, for example, from a pilot's flight controls, an autopilot, a flight control computer, flight director, waypoint navigator, navigation computer, or from another nested-loop control law structure.

Velocity command model 702 may represent the desired dynamics of an aircraft and may provide a filtered version or filtered derivative of the velocity command input 701. Velocity command model 702 creates velocity command 703 and acceleration command 704 outputs in the illustrated example. Acceleration command 704 is provide as an input to a feedforward (FF) path. Both velocity command 703 and acceleration command 704 are provided as references for the feedback paths (FB), which are described below. Acceleration command 704 is provided to a transform 705, which transforms velocity and acceleration inputs to an attitude. Transform 705 generates FF signal 706.

In the illustrated embodiment, block 705 may be a gain that relates the velocity and acceleration commands 703,704 to the inner loop and provides a conversion to an attitude command. Block 705 may be, for example, a constant value or a fixed multiplier factor that relates a desired velocity 703 and acceleration 704 to a desired attitude command 706. In other embodiments having different input command types, there may be additional dynamics (i.e., more than just a gain) associated with the relationship between the input to block 705 and the attitude command 706 at the output of block 705. Block 705 may be, for example, an inverse plant that comprises the inverse of the dynamics of the attitude being controlled.

The attitude command 706 output from block 705 is provided to feedforward saturation 707. Saturation block 707 limits the maximum and minimum attitude commands 706 to some predetermined upper and lower bounds. In the example illustrated in FIG. 7, the acceptable attitude commands at saturation 707 are in units of degrees of vehicle attitude. If the nested-loop model-following control law structure was part of a heading controller, for example, then the saturation may have units of yaw rate.

The feedforward path 708 and the outer loop feedback 709 are summed at 710 to create an inner loop command that is applied to attitude command saturation 711. The outer loop feedback 709 and the feedforward signal 706 are both in terms of the inner loop command variable, which is degrees of vehicle attitude in this example. Like feedforward saturation 707, attitude command saturation 711 limits the bounds of an attitude command 712 provided to the inner loop controller 713. The attitude command 712 is the inner loop command for the nested-loop model-following control law structure 700. Inner loop controller 713 may be, for example, an attitude command controller.

Inner loop controller 713 outputs a mixer command 714, which may be commands to the plant 715 to control effectors or actuators. Plant block 715 represents the aircraft dynamics with the effectors set according to command 714. Plant 715 provides the aircraft's state, such as the aircrafts current acceleration 716, velocity 717, attitude 718, and rate 719. The aircraft states may be measured, for example, using sensors on the aircraft. Alternatively, the outputs used as feedback signals may be estimated instead of being directly measured.

Aircraft attitude 718 and aircraft rate 719 are in terms of the inner loop controller 713, such as degrees of attitude. Accordingly, those values 718, 719 are provided as an inner feedback loop 720 to controller 713.

Aircraft acceleration 716 and aircraft velocity 717 are in the terms generated by the original command model 702. Accordingly, those values 716, 717 are in an outer feedback loop 721 to be summed with the outputs of velocity command model 702. The outer feedback path has a PID (proportional-integral-derivative) structure.

A time delay 722 is applied to acceleration command 704 from command model 702. The delay 722 accounts for signal transport in the feedforward and feedback loops, sensor delays, and actuator delays and serves to synchronize the model commands and the feedback. The difference between the delayed acceleration command 723 and the feedback acceleration 716 is determined at block 724 to create an acceleration error signal 725. The acceleration error signal 725 is multiplied by a gain 726 to generate a derivative attitude error 727. Gain 726 may be, for example, a constant value or a fixed multiplier factor that relates acceleration to attitude.

A time delay 728 is applied to velocity command 703 from command model 702. The difference between the delayed velocity command 729 and the feedback velocity 717 is determined at block 730 to create a velocity error signal 731. The velocity error signal 725 is multiplied by a gain 732 to generate a proportional attitude error 733. The velocity error signal 725 is also multiplied by a gain 734 and summed over time 735 to generate an integral attitude error 736. Gain 732 and 734 may be, for example, constant values or fixed multiplier factors that relate velocity to attitude.

The proportional 733, integral 736, and derivative 727 error attitude signals are summed in block 737 to create a combined outer loop feedback signal 738. Saturation 739 limits the minimum and maximum bounds of combined outer loop feedback signal 738 and then provides the outer loop feedback 709 to be summed with the feedforward path signal 708.

The nested-loop model-following control law structure 700 is a method of utilizing a two-degree-of-freedom control law within an architecture of nested loop functions. This allows separation of the command and feedback path requirements so that the command and feedback have different responses. This structure also enables the restrictions of the inner loops to be applied to the outer loop feedbacks. In the example shown in FIG. 7, the command of the velocity loop can be limited in terms of vehicle attitudes instead of just effector commands. Additionally, the structures allow for independent tuning of the feedforward and feedback paths. For example, the gains on the feedback path can be adjusted independently of the gains on the feedforward path, which allows for the feedback response to be completely independent of the reference command input.

Although a velocity command model 702 and a desired velocity and acceleration to attitude transformation 705 are illustrated in the example of FIG. 7, it will be understood that other loops may use other command models 702 and transforms 705 depending upon the parameters being controlled. For example, in a heading hold loop, a heading response command model may be used with a transform that translates a heading rate into a bank angle that is a function of airspeed. An altitude hold loop may use an altitude command model that generates a vertical velocity command (e.g., an h-dot (h) command) and a transform may translate the vertical velocity command to a pitch attitude. Other appropriate command models 702 and transforms 705 may be selected for loops to maintain translational rate, position, altitude, flight path angle, vertical velocity, or any other aircraft parameter.

In one embodiment, a flight control computer, flight controller, flight director, waypoint navigator, navigation computer, or autopilot controller applies a model-following control law with command models and inverse plants arranged in a nested loop structure wherein the outer loops are subject to inner loop authority constraints. The control law may be applied to a lateral TRC mode, a heading mode, a position mode, an altitude mode, a velocity mode, etc., wherein the control law holds a translation rate, heading, position, altitude, velocity, or other control input. The control law may incorporate an explicit model follower that is cast into traditional nested loops with inner loop authority enforcement. The control law structure disclosed herein enables outer loop integral action without typical overshoot.

In other embodiments, a rotorcraft or a tiltrotor aircraft may provide an in-detent hold function that maintains a position designated when a control stick is centered or “in-detent”. The in-detent hold function may be activated by initializing, and switching on, a next loop out from a currently commanded variable.

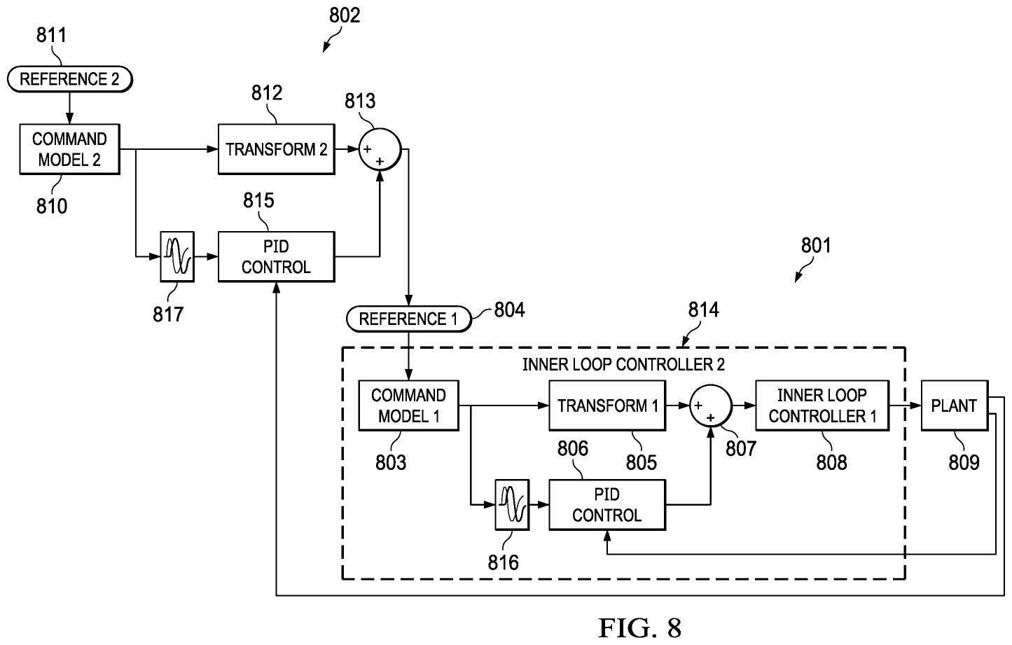

FIG. 8 is a block diagram illustrating a set of nested loops 801 and 802 in which the input to nested loop 801 is generated by loop 802. Each individual loop 801 and 802 uses the nested-loop model-following control law structure illustrated in FIGS. 6 and 7. In the example of FIG. 8, the inner loop control signal generated by loop 802 serves as the reference signal for nested loop 801. Nested loop 801 functions as the inner loop controller for loop 802.

Loop 801 comprises a first command model 803 that receives inputs from first reference signal 804. Command model 803 provides an output to first transform 805 and to a first feedback loop. Transform 805 generates a first feedforward signal to summing junction 807, which uses a first feedback signal to create an inner loop command for first inner loop controller 808. Plant 809 receives commands from inner loop controller 808 and provides first plant feedback to PID control 806. The output of command model 803 is delayed at 816 and then combined with the first plant feedback in PID control 806, which sends the first feedback signal to summing junction 807.

Loop 802 comprises a second command model 810 that receives inputs from second reference signal 811. Command model 810 provides an output to second transform 812 and to a second feedback loop. Transform 812 generates a second feedforward signal to summing junction 813, which uses a second feedback signal to create a second inner loop command. This second inner loop command functions as the first reference signal 804. As noted above, nested loop 801 functions as a second inner loop controller 814 using the second inner loop command as an input. Second plant feedback from plant 809 are provided to PID control 815. The output of command model 810 is delayed at 817 and then combined with the second plant feedback at PID control 815, which sends the second feedback signal to summing junction 813.

Second reference 811 may be a pilot input using flight controls, an autopilot command, or a flight computer command, for example. In other embodiments, one or more additional outer nested loops such as loop 802 may be used to create the second reference command 811.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A method for controlling an aircraft effector, comprising:
applying a reference command to a command model;
translating at least one output of the command model to a forward path signal using a transform;
combining the forward path signal with an outer loop feedback signal to create an inner loop command;
applying the inner loop command to an inner loop controller; and
generating an effector command using the inner loop controller, wherein the effector command is used to control the aircraft effector.

2. The method of claim 1, further comprising:
generating at least one aircraft feedback signal representing an aircraft parameter; and
combining the at least one aircraft feedback signal with a corresponding output of the command model to create the outer loop feedback signal.

3. The method of claim 2, further comprising:
generating at least one additional aircraft feedback signal representing an aircraft parameter; and
providing the at least one additional aircraft feedback signal to the inner loop controller as an inner loop feedback signal.

4. The method of claim 1, wherein the reference command is selected from one of: a translational rate command (TRC), a heading, a position, an altitude, a velocity, a flight path angle, a vertical velocity, a load factor, a pitch rate, a roll rate, and an angle of attack.

5. The method of claim 1, further comprising:
receiving the reference command from a flight control system, a flight control computer, flight director, waypoint navigator, navigation computer, or an autopilot.

6. The method of claim 1, wherein the reference command is received from a second outer loop, and wherein the reference command corresponds to a second inner loop command generated in the second outer loop.

7. The method of claim 1, wherein the at least one output of the command model corresponds to one or more of a filtered version of the reference command and a derivative of the filtered reference command.

8. The method of claim 5, wherein the outer loop feedback signal is created in a proportional, integral, and derivative (PID) loop.

9. The method of claim 1, wherein the aircraft effector is a control surface, a propellor, or an actuator configured to control the position of the control surface or propellor.

10. The method of claim 1, wherein the inner loop command is an attitude, rate, load factor, or angle of attack command.

11. The method of claim 1, wherein the command model represents desired dynamics of an aircraft.

12. A flight control system for an aircraft, comprising:
a flight control computer configured to control aircraft effectors in response to a control law, the flight control computer comprising one or more processors and a memory, wherein the memory stores instructions for executing the control law, the instructions causing the flight control computer to perform the steps of:
applying a reference command to a command model;
applying one or more command model outputs to a transform to create a forward path signal;
combining the forward path signal with a feedback signal to create an inner loop command;
applying the inner loop command to an inner loop controller;
generating an aircraft effector command using the inner loop controller;
receiving at least one aircraft feedback signal representing an aircraft parameter;
combining the at least one aircraft feedback signal with the one or more command model outputs a to create the feedback signal.

13. The flight control system of claim 12, wherein the instructions further causing the flight control computer to perform the steps of:
receiving at least one additional aircraft feedback signal representing an aircraft parameter; and
providing the at least one additional aircraft feedback signal to the inner loop controller as an inner loop feedback signal.

14. The flight control system of claim 12, wherein the reference command is selected from one of: a translational rate command (TRC), a heading, a position, an altitude, a velocity, a flight path angle, a vertical velocity, a load factor, a pitch rate, a roll rate, and an angle of attack.

15. The flight control system of claim 12, wherein the instructions further causing the flight control computer to perform the steps of:
receiving the reference command from a flight control system, a flight control computer, flight director, waypoint navigator, navigation computer, or an autopilot.

16. The flight control system of claim 12, wherein the instructions further causing the flight control computer to perform the steps of:
generating the reference command in a nested outer loop, and wherein the reference command corresponds to a second inner loop command generated in the nested outer loop.

17. The flight control system of claim 12, wherein the at least one output of the command model corresponds to one or more of a filtered version of the reference command and a derivative of the filtered reference command.

18. The flight control system of claim 12, wherein the outer loop feedback signal is created in a filtered proportional, integral, and derivative (PID) loop.

19. The flight control system of claim 12, wherein the aircraft effector is a rotor cyclic control, a rotor/propellor collective control, an electric motor speed, torque, or current command, a control surface, a propellor, or an actuator configured to control the position of the control surface or propellor.

20. The flight control system of claim 12, wherein the inner loop command is an attitude, rate, load factor, or angle of attack command.
